(19) United States
(12) Patent Application Publication
(10) Pub. No.: US 2025/0036018 A1
(43) Pub. Date: Jan. 30, 2025

(54) PROJECTION SCREEN

(71) Applicant: LINTEC CORPORATION, Tokyo (JP)

(72) Inventors: Akihira WATANABE, Tokyo (JP); Kentaro KUSAMA, Tokyo (JP)

(73) Assignee: LINTEC CORPORATION, Tokyo (JP)

(21) Appl. No.: 18/705,058

(22) PCT Filed: Oct. 31, 2022
(86) PCT No.: PCT/JP2022/040582

§ 371 Date: Apr. 26, 2024

(30) Foreign Application Priority Data
Oct. 29, 2021 (JP) 2021-177506

(51) Int. Cl. G03B 21/62

(52) U.S. Cl. CPC G03B 21/62

(57) ABSTRACT

Provided is a projection screen used by being attached to an optically transparent adherend. The projection screen includes a transparent base material and a pressure sensitive adhesive layer. The luminance at frontal 0° on the transparent base material side as measured using transmitted light from a white light source of 1100 cd/m² is 10 cd/m² or more and 400 cd/m² or less. The luminance ratio of a luminance at diagonal 45° on the transparent base material side as measured using transmitted light from a white light source of 1100 cd/m² with respect to the luminance at frontal 0° is 0.5 or more. According to the projection screen, it is possible to achieve both the background visibility when the projector is turned off and the frontal and diagonal visibility when the projector is turned on.

### TECHNICAL FIELD

The present invention relates to a projection screen that is used by being attached to an optically transparent adherend.

### BACKGROUND ART

In recent years, projectors have been used to display images (including the concept of video) in various places. Among these, as an example, a transmissive projection screen that is used by being attached to glass such as a show window is becoming known. The transmissive projection screen displays images projected from a projector to a viewer who is on the opposite side of the projector across the glass to which the transmissive projection screen is attached.

As an example of such a transmissive projection screen, one described in Patent Document 1 has been proposed. Specifically, an attachment type projection screen is proposed, which is configured to include a base material and a light-diffusing layer, and in which the light-diffusing layer contains a silicone resin and organic fine particles having an average particle diameter of 1 to 10 μm, the thickness of the light-diffusing layer is 5 to 30 μm, the 180° peel strength on the light-diffusing layer side is 20 to 200 mN/25 mm, and the haze value is 20% or more.

According to the above projection screen, advantageous effects can be obtained that it is configured to be thin enough not to cause image blurring, yet has sufficient projection performance as a transmissive screen, is excellent in the interfacial adhesion to an adherend such as glass and in the durability, and is also excellent in the releasability, and even when it is used again after being released, the visibility of video does not deteriorate due to the inclusion of air bubbles or the like.

### PRIOR ART DOCUMENTS

### Patent Documents

[Patent Document 1] JP6633955B

### SUMMARY OF THE INVENTION

### Problems to be Solved by the Invention

In the projection screen described in Patent Document 1, however, when the projector is turned off, the background on the opposite side of the glass or the like to which the projection screen is attached may appear blurred, and background visibility may not be necessarily sufficient. Moreover, even though the image visibility in front of the projection screen is sufficient when the projector is turned on, there is a problem in that the image visibility in a diagonal direction may deteriorate.

The present invention has been made in view of such actual circumstances, and an object of the present invention is to provide a projection screen that can achieve both the background visibility when the projector is turned off and the frontal and diagonal visibility when the projector is turned on.

### Means for Solving the Problems

To achieve the above object, the present invention provides a projection screen used by being attached to an optically transparent adherend, the projection screen comprising: a transparent base material; and a pressure sensitive adhesive layer, wherein a luminance at frontal 0° on the transparent base material side as measured using transmitted light from a white light source of 1100 cd/m² is cd/m² or more and 400 cd/m² or less, and a luminance ratio of a luminance at diagonal 45° on the transparent base material side as measured using transmitted light from a white light source of 1100 cd/m² to the luminance at frontal 0° is 0.5 or more (Invention 1).

By satisfying the above physical properties, the projection screen according to the invention (Invention 1) is excellent in the background visibility because the background on the opposite side of an adherend to which the projection screen is attached can be clearly seen when the projector is turned off. Moreover, when the projector is turned on, not only the image visibility in front of the projection screen but also the image visibility in a diagonal direction is satisfactory.

In the above invention (Invention 1), the luminance at diagonal 45° on the transparent base material side as measured using the transmitted light from the white light source of 1100 cd/m² may be preferably 10 cd/m² or more and 400 cd/m² or less (Invention 2).

In the above invention or inventions (Inventions 1 and 2), the haze value may be preferably 1.0% or more and 70% or less (Invention 3).

In the above invention or inventions (Inventions 1 to 3), the total luminous transmittance may be preferably 50% or more (Invention 4).

In the above invention or inventions (Inventions 1 to 4), the pressure sensitive adhesive layer may be preferably composed of a silicone-based pressure sensitive adhesive composition (Invention 5).

In the above invention or inventions (Inventions 1 to 5), a pressure sensitive adhesive composition that constitutes the pressure sensitive adhesive layer may preferably contain light-diffusing fine particles (Invention 6).

In the above invention (Invention 6), the light-diffusing fine particles may be preferably inorganic fine particles (Invention 7).

In the above invention or inventions (Inventions 1 to 7), a hard coat layer may be provided on a surface of the transparent base material opposite to the pressure sensitive adhesive layer (Invention 8).

### Advantageous Effect of the Invention

According to the projection screen of the present invention, it is possible to achieve both the background visibility when the projector is turned off and the frontal and diagonal visibility when the projector is turned on.

### BRIEF DESCRIPTION OF DRAWINGS

FIG. 1 is a sectional view illustrating a projection screen according to an embodiment of the present invention.

FIG. 2 is a plan view illustrating an example of use of the projection screen according to an embodiment of the present invention (an entire view including a projector when viewed from above).

### EMBODIMENTS FOR CARRYING OUT THE INVENTION

Hereinafter, one or more embodiments of the present invention will be described.

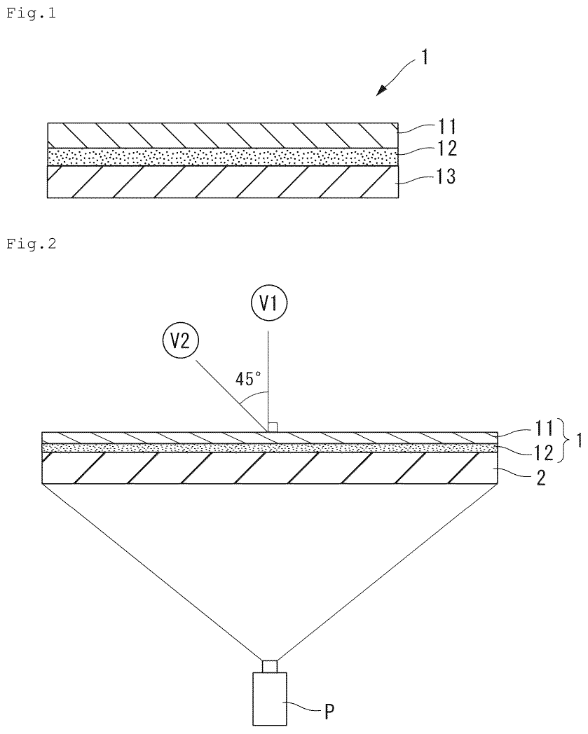

FIG. 1 illustrates a cross-sectional view of a projection screen according to an embodiment of the present invention. FIG. 2 illustrates an example of use of the projection screen according to an embodiment of the present invention (an entire view including a projector when viewed from above).

As illustrated in FIGS. 1 and 2, a projection screen 1 according to the present embodiment is used by being attached to an optically transparent adherend 2, and is composed of a transparent base material 11 and a pressure sensitive adhesive layer 12 laminated on one surface side of the transparent base material 11. In the present embodiment, a release sheet 13 is laminated on the surface of the pressure sensitive adhesive layer 12 opposite to the transparent base material 11, and the release sheet 13 may be removed from the pressure sensitive adhesive layer 12 when the projection screen 1 is used.

In the projection screen 1 according to the present embodiment, the luminance at frontal 0° (directly in front of a light source) (frontal 0° luminance) on the transparent base material 11 side as measured using transmitted light from a white light source of 1100 cd/m² is preferably 10 cd/m² or more and 400 cd/m² or less, and the luminance ratio of a luminance at diagonal 45° (diagonal 45° luminance) on the transparent base material 11 side as measured using transmitted light from the white light source of 1100 cd/m² with respect to the above luminance at frontal 0° (diagonal 45° luminance/frontal 0° luminance) is preferably 0.5 or more. The details of a method of measuring the luminance in the present specification are as described in the testing example, which will be described later. The “frontal 0° on the transparent base material 11 side in the projection screen 1” corresponds to the position of a viewer V1 illustrated in FIG. 2 (plan view), and the “diagonal 45° on the transparent base material 11 side in the projection screen 1” corresponds to the position of a viewer V2 illustrated in FIG. 2 (plan view).

By satisfying the above physical properties, the projection screen 1 according to the present embodiment is excellent in the background visibility because the background on the opposite side of an adherend to which the projection screen 1 is attached can be clearly seen when the projector is turned off. Moreover, when the projector is turned on, not only the image visibility in front of the projection screen 1 but also the image visibility in a diagonal direction is satisfactory. That is, according to the projection screen 1 of the present embodiment, it is possible to achieve both the background visibility when the projector is turned off and the frontal and diagonal visibility when the projector is turned on.

From the viewpoint of the above effects, the above frontal 0° luminance may be preferably 10 cd/m² or more, more preferably 20 cd/m² or more, particularly preferably 30 cd/m² or more, and further preferably 50 cd/m² or more. This allows the image visibility to be excellent especially in the front when the projector is turned on. Additionally or alternatively, the frontal 0° luminance may be preferably 400 cd/m² or less, more preferably 300 cd/m² or less, particularly preferably 200 cd/m² or less, and further preferably 150 cd/m² or less. This allows the background visibility to be excellent especially when the projector is turned off. In particular, when the above frontal 0° luminance is 400 cd/m² or less, it is possible to suppress deterioration in the background visibility due to the haze value.

Additionally or alternatively, from the viewpoint of the above effects, the above luminance ratio may be preferably 0.50 or more, more preferably 0.60 or more, particularly preferably 0.75 or more, and further preferably 0.90. In particular, when the above luminance ratio is 0.50 or more, excellent screen performance can be developed with low haze and small angle dependence. The upper limit of the above luminance ratio is not particularly limited, but may be preferably 1.00 or less, more preferably 0.99 or less, and particularly preferably 0.98 or less.

The above diagonal 45° luminance may be preferably 10 cd/m² or more, more preferably 20 cd/m² or more, particularly preferably 30 cd/m² or more, and further preferably 50 cd/m² or more. This allows the above luminance ratio to be readily satisfied, and the diagonal visibility when the projector is turned on can be more excellent. Additionally or alternatively, the above diagonal 45° luminance may be preferably 400 cd/m² or less, more preferably 300 cd/m² or less, particularly preferably 200 cd/m² or less, and further preferably 150 cd/m² or less. This allows the background visibility to be more excellent when the projector is turned off.

The haze value of the projection screen 1 according to the present embodiment may be preferably 1.0% or more, more preferably 2.0% or more, particularly preferably 3.0% or more, and further preferably 5.0% or more. This allows the previously described physical properties to be readily satisfied. Additionally or alternatively, the above haze value may be preferably 70% or less, more preferably 50% or less, particularly preferably 25% or less, and further preferably 20% or less. This allows the previously described physical properties to be readily satisfied, and in particular the background visibility can be excellent when the projector is turned off. The method of measuring the haze value is as described in the testing example, which will be described later.

The total luminous transmittance of the projection screen 1 according to the present embodiment may be preferably 50% or more, more preferably 70% or more, particularly preferably 80% or more, and further preferably 83% or more. This allows the previously described physical properties to be readily satisfied, and in particular the background visibility can be excellent when the projector is turned off. The upper limit of the above total luminous transmittance is not particularly limited, but from the viewpoint of readily satisfying other physical property values, the upper limit may be preferably 100% or less, more preferably 99% or less, particularly preferably 95% or less, and further preferably 89% or less. The method of measuring the total luminous transmittance is as described in the testing example, which will be described later.

### 1. Each Element

### 1-1. Transparent Base Material

The transparent base material 11 in the present embodiment is not particularly limited, provided that it can hold and protect the pressure sensitive adhesive layer 12 and does not hinder the image visibility. Examples of such a transparent base material 11 include plastic films, plastic plates, and glass plates. Among these, plastic films may be preferred because they are flexible and can be easily attached to adherends.

Examples of plastic films include films of polyesters such as polyethylene terephthalate, polybutylene terephthalate, and polyethylene naphthalate, polyolefin films such as polyethylene films and polypropylene films, cellophane, diacetyl cellulose films, triacetyl cellulose films, acetyl cellulose butyrate films, polyvinyl chloride films, polyvinylidene chloride films, polyvinyl alcohol films, ethylene-vinyl acetate copolymer films, polystyrene films, polycarbonate films, polymethylpentene films, polysulfone films, polyetheretherketone films, polyethersulfone films, polyether imide films, fluororesin films, polyamide films, acrylic resin films, polyurethane resin films, norbornene-based polymer films, cyclic olefin-based polymer films, cyclic conjugated diene-based polymer films, vinyl alicyclic hydrocarbon polymer films, other similar plastic films, and laminated films thereof. Among these, polyethylene terephthalate films, polycarbonate films, or the like may be preferred from the viewpoint of transparency, mechanical strength, etc.

For the purpose of improving the interfacial adhesion of the above plastic film with a layer (such as the pressure sensitive adhesive layer 12 or a hard coat layer) provided on the surface of the plastic film, one surface or both surfaces of the plastic film may be subjected to surface treatment, such as using primer treatment, oxidation method, or roughening method, as necessary. Examples of the oxidation method include corona discharge treatment, chromic acid treatment, flame treatment, hot-air treatment, and ozone/ultraviolet treatment. Examples of the roughening method include a sandblast method and a solvent treatment method. These surface treatment methods may be appropriately selected depending on the type of the plastic film, and the corona discharge treatment method may be preferably used in view of the effect, the operability, etc. in general.

The thickness of the plastic film may be preferably 10 to 400 μm, more preferably 15 to 300 μm, particularly preferably 20 to 250 μm, and further preferably 25 to 200 μm from the viewpoint of handling properties, transparency, mechanical strength, etc.

Examples of plastic plates include, but are not limited to, acrylic plates and polycarbonate plates. The thickness of the plastic plate is not particularly limited, but may be usually 0.3 to 5 mm and preferably 0.5 to 3 mm.

Examples of glass plates include, but are not limited to, chemically strengthened glass, alkali-free glass, quartz glass, soda lime glass, barium/strontium-containing glass, aluminosilicate glass, lead glass, borosilicate glass, and barium borosilicate glass. The thickness of the glass plate is not particularly limited, but may be usually 0.1 to 5 mm and preferably 0.2 to 3 mm.

### 1-2. Pressure Sensitive Adhesive Layer

The pressure sensitive adhesive layer 12 in the present embodiment may be preferably composed of a silicone-based pressure sensitive adhesive composition. When the pressure sensitive adhesive layer 12 is composed of a silicone-based pressure sensitive adhesive composition, the background visibility when the projector is turned off and the diagonal visibility when the projector is turned on are particularly satisfactory as compared, for example, to an acrylic-based pressure sensitive adhesive composition. This is because the silicone-based pressure sensitive adhesive composition has a lower refractive index than an acrylic pressure sensitive adhesive composition, so the difference in refractive index between the silicone-based pressure sensitive adhesive composition and the light-diffusing fine particles, which will be described late, is large, and the light diffusion region is widened. Moreover, provided that the pressure sensitive adhesive layer 12 is composed of a silicone-based pressure sensitive adhesive composition, when glass such as a show window is used as an adherend, the projection screen 1 has excellent handling properties in terms of its attachment/release. In particular, silicone-based pressure sensitive adhesive compositions can be made to have low tackiness, and by using a silicone-based pressure sensitive adhesive composition with low tackiness, the releasability (reworkability) from an adherend can be excellent.

The above silicone-based pressure sensitive adhesive composition may preferably contain a silicone-based pressure sensitive adhesive and light-diffusing fine particles. By containing light-diffusing fine particles, the previously described optical properties can be readily satisfied.

### (1) Each Component

### (1-1) Silicone-Based Pressure Sensitive Adhesive

The silicone-based pressure sensitive adhesive may be a condensation type silicone-based pressure sensitive adhesive or addition an reaction type silicone-based pressure sensitive adhesive, but from the viewpoint of reworkability, an addition reaction type silicone-based pressure sensitive adhesive may be preferred.

The addition reaction type silicone-based pressure sensitive adhesive may be preferably one that contains as the main ingredient an addition reaction type silicone resin obtained from a first polydimethylsiloxane having at least two alkenyl groups in one molecule and a second polydimethylsiloxane having at least two hydrosilyl groups in one molecule and may be particularly preferably one that further contains a silicone resin.

Examples of the alkenyl groups contained in the first polydimethylsiloxane include monovalent hydrocarbon groups such as vinyl groups, allyl groups, propenyl groups, butenyl groups, pentenyl groups, hexenyl groups, heptenyl groups, and octenyl groups, among which vinyl groups may be particularly preferred.

The content of alkenyl groups in the first polydimethylsiloxane (ratio of the number of alkenyl groups to the number of methyl groups bonded to silicon atoms) may be preferably 0.005 to 0.1 mol % and particularly preferably 0.01 to 0.05 mol %. The alkenyl groups may be preferably present at both ends of the molecular chain and may also be present at side chains. Since at least two alkenyl groups are contained in one molecule the of first polydimethylsiloxane and the content of alkenyl groups is within the above range, a crosslinked structure having a high crosslinking density is formed, and the pressure sensitive adhesive layer 12 can be obtained with excellent reworkability.

The degree of polymerization (number of siloxane bonds) of the first polydimethylsiloxane may be preferably 200 to 5,000 and particularly preferably 500 to 3,000. The content of hydrosilyl groups in the second polydimethylsiloxane may be preferably 2 to 300 and particularly preferably 4 to 200 in one molecule. The degree of polymerization of the second polydimethylsiloxane may be preferably 50 to 2,000 and particularly preferably 100 to 1,500. The compounding ratio of the second polydimethylsiloxane to 100 mass parts of the first polydimethylsiloxane may be preferably 0.01 to 20 mass parts and particularly preferably 0.1 to 10 mass parts. When the content of each functional group and the compounding ratio of the second polydimethylsiloxane to the first polydimethylsiloxane are within the above ranges, the addition reaction between the first polydimethylsiloxane and the second polydimethylsiloxane can be carried out satisfactorily.

Preferably, the first polydimethylsiloxane may not have a hydrosilyl group, and the second polydimethylsiloxane preferably may not have an alkenyl group.

The weight-average molecular weight of the first polydimethylsiloxane may be preferably 20,000 to 1, 300,000 and particularly preferably 300,000 to 1,200,000. The weight-average molecular weight of the second polydimethylsiloxane may be preferably 300 to 1,400 and particularly preferably 500 to 1,200. As used in the present specification, the weight-average molecular weight refers to a standard polystyrene equivalent value that is measured using a gel permeation chromatography (GPC) method.

As the silicone resin, for example, MQ resin composed of M units which are monofunctional siloxane units [(CH₃)₃SiO_{1/2}] and Q units which are tetrafunctional siloxane units [SiO_{4/2}] can be used. The molar ratio of M units/Q units may be preferably 0.6 to 1.7. This silicone resin has a role of imparting tackiness to the silicone-based pressure sensitive adhesive.

The compounding amount of silicone resin to 100 mass parts of the addition reaction type silicone resin may be preferably 1 mass part or more, particularly preferably 3 mass parts or more, and further preferably 5 mass parts or more as the lower limit. When the lower limit of the compounding amount of silicone resin is as above, a desired adhesive strength can be obtained, and it is possible to prevent the obtained projection screen 1 from being unintentionally released from the adherend. Additionally or alternatively, the above compounding amount may be preferably 40 mass parts or less, particularly preferably 30 mass parts or less, and further preferably 20 mass parts or less as the upper limit. When the upper limit of the compounding amount of silicone resin is as above, it is possible to prevent the adhesive strength from being unduly high and ensure the reworkability of the obtained projection screen 1.

The above addition reaction type silicone pressure sensitive adhesive may preferably contain a catalyst. The catalyst is not particularly limited, provided that it can cure the above addition reaction type silicone resin (it can enable the addition reaction between the first polydimethylsiloxane and the second polydimethylsiloxane), but platinum group metal-based compounds may be particularly preferred. Examples of the platinum group metal-based compounds include finely particulate platinum, finely particulate platinum adsorbed on a carbon powder carrier, chloroplatinic acid, alcohol-modified chloroplatinic acid, olefin complexes of chloroplatinic acid, palladium, and rhodium. By containing such a catalyst, the curing reaction of the addition reaction type silicone resin can be progressed more efficiently.

The platinum content of the compounded catalyst may be preferably 0.01 to 3 mass parts and particularly preferably 0.05 to 2 mass parts with respect to 100 mass parts of the above addition reaction type silicone resin.

### (1-2) Light-Diffusing Fine Particles

The light-diffusing fine particles may be of any type, provided that they can satisfy the previously described optical properties, but inorganic fine particles may be particularly preferred. Inorganic fine particles allow the previously described optical properties to be readily satisfied.

Examples of inorganic fine particles include metal oxides such as silica, aluminum oxide, zirconium oxide, titanium oxide, zinc oxide, germanium oxide, indium oxide, tin oxide, indium tin oxide (ITO), antimony oxide, and cerium oxide; and fine particles composed of metal fluorides and the like such as magnesium fluoride and sodium fluoride. Among the above, metal oxides may be preferred from the viewpoint of the haze developing properties and the dispersibility in the silicone-based pressure sensitive adhesives, titanium oxide or zinc oxide may be particularly preferred, and titanium oxide may be further preferred. The surfaces of the inorganic fine particles may be chemically modified with an organic compound or the like.

The shape of the inorganic fine particles may be any of true spherical shape, indefinite shape, etc., but from the viewpoint of efficiently exhibiting the light-diffusing properties with a small amount, the infinite shape may be preferred.

The light-diffusing fine particles in the present embodiment may be preferably so-called nanoparticles. Specifically, the average particle diameter of the light-diffusing fine particles may be preferably 1000 nm or less, more preferably 700 nm or less, particularly preferably 500 nm or less, and further preferably 300 nm or less. Additionally or alternatively, the average particle diameter of the light-diffusing fine particles may be preferably 10 nm or more, more preferably 20 nm or more, particularly preferably 50 nm or more, and further preferably 100 nm or more. When the average particle diameter of the light-diffusing fine particles is within the above range, the previously described optical properties may be more readily satisfied. The average particle diameter of the light-diffusing fine particles is measured by a laser diffraction/scattering method.

The refractive index of the light-diffusing fine particles in the present embodiment may be preferably 1.8 or more, more preferably 1.9 or more, particularly preferably 2.0 or more, and further preferably 2.5 or more. Additionally or alternatively, the refractive index of the light-diffusing fine particles may be preferably 3.0 or less, more preferably 2.9 or less, particularly preferably 2.8 or less, and further preferably 2.7 or less. When the refractive index of the light-diffusing fine particles is within the above range, the previously described optical properties may be more readily satisfied. The refractive index of the light-diffusing fine particles can be measured, for example, by the following method. That is, a sample is prepared through placing fine particles on a slide glass, dropping a refractive index standard solution onto the fine particles, and covering the fine particles with a cover glass. The sample is observed with a microscope, and the refractive index of the refractive index standard solution at which the outline of the fine particles becomes most difficult to see may be determined as the refractive index of the fine particles.

The content of light-diffusing fine particles in the silicone-based pressure sensitive adhesive composition may be preferably 0.001 mass parts or more, more preferably 0.01 mass parts or more, particularly preferably 0.1 mass parts or more, and further preferably 0.2 mass parts or more with respect to 100 mass parts of the silicone-based pressure sensitive adhesive. Additionally or alternatively, the content may be preferably 3.0 mass parts or less, more preferably 2.0 mass parts or less, particularly preferably 1.0 mass parts or less, and further preferably 0.4 mass parts or less. This allows the previously described optical properties to be more readily satisfied.

### (1-3) Other Components

The silicone-based pressure sensitive adhesive composition in the present embodiment may contain various additives in addition to the above components. Examples of such additives include ultraviolet absorbers, leveling agents, dispersants, antioxidants, light stabilizers, antistatics, silane coupling agents, anti-aging agents, thermal polymerization inhibitors, colorants, refractive index adjusters, surfactants, storage stabilizers, plasticizers, glidants, antifoamers, wettability improvers, coating surface improvers, antifoulants, antibacterial agents, and antiviral agents.

Examples of ultraviolet absorbers include benzotriazole-based, benzophenone-based, benzoate-based, benzoxazinone-based, triazine-based, phenyl salicylate-based, cyanoacrylate-based, and nickel complex salt-based compounds. These may each be used alone or two or more types may also be used in combination.

When the silicone-based pressure sensitive adhesive composition contains an ultraviolet absorber, the content of the ultraviolet absorber may be preferably 0.01 mass parts or more, more preferably 0.1 mass parts or more, particularly preferably 1.0 mass parts or more, and further preferably 2.0 mass parts or more with respect to 100 mass parts of the silicone-based pressure sensitive adhesive composition. Additionally or alternatively, the content may be preferably 10 mass parts or less, more preferably 8 mass parts or less, particularly preferably 6 mass parts or less, and further preferably 5 mass parts or less. This allows satisfactory ultraviolet absorption properties to be obtained.

When the silicone-based pressure sensitive adhesive composition contains an ultraviolet absorber, the luminous transmittance of the projection screen 1 at a wavelength of 380 nm may be preferably 50% or less, more preferably 10% or less, particularly preferably 5% or less, and further preferably 1% or less. This allows excellent ultraviolet absorption properties to be obtained. The lower limit of the above luminous transmittance may be most preferably 0%, but usually it may be preferably 0.001% or more and more preferably 0.01% or more. The method of measuring the luminous transmittance at a wavelength of 380 nm in the present specification is as described in the testing example, which will be described later.

### (2) Thickness

From the viewpoint of pressure sensitive adhesive properties, the thickness of the pressure sensitive adhesive layer 12 may be preferably 5 μm or more, more preferably 10 μm or more, particularly preferably 15 μm or more, and further preferably 25 μm or more. Additionally or alternatively, from the viewpoint of smoothness of the surface of the pressure sensitive adhesive layer, the thickness of the pressure sensitive adhesive layer 12 may be preferably 1000 μm or less, more preferably 500 μm or less, particularly preferably 100 μm or less, and further preferably 50 μm or less.

### 1-3. Hard Coat Layer

In the projection screen 1 according to the present embodiment, it is also preferred that a hard coat layer should be provided on the surface of the transparent base material 11 opposite to the pressure sensitive adhesive layer 12. By providing such a hard coat layer, the scratch resistance of the projection screen 1 can be improved.

The above hard coat layer can be provided with various functions, such as infrared absorbing properties, anti-glare properties, antibacterial properties, and antiviral properties.

The material of the above hard coat layer is not particularly limited, and conventionally known materials can be used. For example, the hard coat layer may be preferably formed using a material that contains an energy ray-curable compound. Examples of the energy ray-curable compound include acrylic-based monomers or oligomers, and specific examples include polyfunctional (meth) acrylates, urethane (meth) acrylates, and polyester (meth) acrylates. It may also be preferred to contain a component that exhibits the above functions, as necessary.

The thickness of the hard coat layer is not particularly limited, and may be preferably 1 μm or more and particularly preferably 2 μm or more. Additionally or alternatively, the thickness may be preferably 20 μm or less and particularly preferably 10 μm or less.

### 1-4. Release Sheet

The release sheet 13 is not particularly limited, provided that it does not adversely affect the pressure sensitive adhesive layer 12. Examples of the release sheet 13 for use include polyethylene films, polypropylene films, polybutene films, polybutadiene films, polymethylpentene films, polyvinyl chloride films, vinyl chloride copolymer films, polyethylene terephthalate films, polyethylene naphthalate films, polybutylene terephthalate films, polyurethane films, ethylene vinyl acetate films, ionomer resin films, ethylene/(meth)acrylic acid copolymer films, ethylene/(meth)acrylic ester copolymer films, polystyrene films, polycarbonate films, polyimide films, and fluororesin films. Moreover, these crosslinked films may also be used. Furthermore, these laminated films may be used. Among the above, polyethylene terephthalate films may be preferred because of their excellent handling properties.

The surface of the above release sheet 13 in contact with the pressure sensitive adhesive layer 12 may not be subjected to a release treatment, that is, there may be no release agent layer, or the surface of the above release sheet 13 in contact with the pressure sensitive adhesive layer 12 may be subjected to a release treatment, for example, using a release agent other than a silicone-based release agent, such as a fluorine-based release agent.

The thickness of the release sheet 13 is not particularly limited, but may be usually preferably 15 to 100 μm and particularly preferably 25 to 75 μm.

### 2. Production Method

To produce the projection screen 1 according to the present embodiment, for example, one surface of the transparent base material 11 is coated with a coating liquid that contains a silicone-based pressure sensitive adhesive composition and that may further contain a diluent if desired, and the coating liquid is then dried to cure to form the pressure sensitive adhesive layer 12.

The above diluent is not particularly limited, and various diluents can be used. For example, hydrocarbon compounds such as toluene, hexane, and heptane as well as acetone, ethyl acetate, methyl ethyl ketone, methyl isobutyl ketone, and mixtures thereof may be used.

The coating with the coating liquid of the silicone-based pressure sensitive adhesive composition may be performed by an ordinary method, such as a bar coating method, a knife coating method, a roll coating method, a blade coating method, a die coating method, or a gravure coating method. After the coating with the above coating liquid, it is preferred to heat and dry the coating film.

When the main ingredient of the silicone-based pressure sensitive adhesive composition is an addition reaction type silicone-based pressure sensitive adhesive, it is preferred to thermally cure the above coating film. In this case, the heating temperature may be preferably 80° C. to 180° C., and the heating time may be preferably about 10 to 120 seconds.

Once the pressure sensitive adhesive layer 12 is formed as described above, the release sheet 13 may be attached to the pressure sensitive adhesive layer 12, if desired, to obtain the projection screen 1.

In the above production method, the pressure sensitive adhesive layer 12 is formed on the transparent base material 11, but the pressure sensitive adhesive layer 12 may be formed on the release sheet 13, and the transparent base material 11 may then be attached to the pressure sensitive adhesive layer 12.

### 3. Method of Use

As illustrated in FIG. 2, after the release sheet 13 is removed from the pressure sensitive adhesive layer 12, the projection screen 1 according to the present embodiment is attached to the optically transparent adherend 2 via the exposed pressure sensitive adhesive layer 12. In FIG. 2, the projection screen 1 is attached to the surface of the adherend 2 on the opposite side to a projector P, but may also be attached to the surface of the adherend 2 on the same side as the projector P.

The optically transparent adherend 2 may be a transparent hard plate such as a glass plate or a plastic plate or a flexible transparent body such as a plastic film. Examples of the adherend 2 include, but are not limited to, show window glass; architectural glass such as window glass, exterior wall glass, or partition glass; glass installed at event site; and window glass of various vehicles.

When the projection screen 1 is used as a transmissive projection screen (when used as a rear projection screen), as illustrated in FIG. 2, an image is projected from the projector P onto the projection screen 1, and the viewers V1 and V2 visually recognize the image projected onto the projection screen 1 from the opposite side of the projection screen 1 to the projector P.

According to the projection screen 1 of the present embodiment, when the projector P is turned on, the image visibility in front of the projection screen 1 (image visibility for the viewer V1) is excellent, and the image visibility in a diagonal direction from the projection screen 1 (e.g., image visibility for the viewer V2) is also excellent. Moreover, when the projector P is turned off, the background on the opposite side of the adherend 2 to which the projection screen 1 is attached can be clearly seen from the viewers V1 and V2, and the background visibility is excellent.

When the projection screen 1 is used as a reflective projection screen (when used as a front projection screen), the viewers V1 and V2 and the projector P are positioned on one side of the adherend 2 and on the same side. Also in this case, the projection screen 1 may be attached to the same side of the adherend 2 as the projector P or may also be attached to the opposite side to the projector P.

The embodiments heretofore explained are described to facilitate understanding of the present invention and are not described to limit the present invention. It is therefore intended that the elements disclosed in the above embodiments include all design changes and equivalents to fall within the technical scope of the present invention.

### EXAMPLES

Hereinafter, the present invention will be described further specifically with reference to examples, etc., but the scope of the present invention is not limited to these examples, etc.

### Example 1

### 1. Preparation of Coating Liquid of Silicone-Based Pressure Sensitive Adhesive Composition

The coating liquid of a silicone-based pressure sensitive adhesive composition was prepared through mixing 100 mass parts (solid content equivalent; here and hereinafter) of an addition reaction type silicone resin (available from Shin-Etsu Chemical Co., Ltd., product name “KS-847H”) as the main ingredient of a silicone pressure sensitive adhesive, 10 mass parts of a silicone resin (available from Dow Toray Co., Ltd., product name “SD-4584”), 2 mass parts of a platinum catalyst (available from Dow Toray Co., Ltd., product name “SRX 212 CATALYST”), and 0.1 mass parts of titanium oxide fine particles (P1; available from Sakai Chemical Industry Co., Ltd., product name “R-62N,” indefinite shape, average particle diameter: 260 nm, refractive index: 2.7) as the light-diffusing fine particles and diluting them with methyl ethyl ketone.

### 2. Production of Projection Screen

After one surface of a polyethylene terephthalate film (available from TOYOBO CO., LTD., product name “COSMOSHINE A4360,” thickness: 50 μm) as the transparent base material was coated, using a knife coater, with the coating liquid of the silicone-based pressure sensitive adhesive composition obtained in the above step, they were subjected to heating treatment at 130° C. for 1 minute to form a pressure sensitive adhesive layer having a thickness of 25 μm. Then, a polyethylene terephthalate (PET) film (available from Toray Industries, Inc., product name “Lumirror T-60,” no release agent layer, thickness: 38 μm) as the release sheet was attached to the pressure sensitive adhesive layer, and a projection screen (with release sheet) was thus obtained.

### Examples 2 to 7 and Comparative Examples 1 and 2

Projection screens were produced in the same manner as in Example 1 except that the types and compounding amounts of the light-diffusing fine particles were as listed in Table 1 in preparing the coating liquid of the silicone-based pressure sensitive adhesive composition. In Example 5, 4.0 mass parts of a benzophenone-based ultraviolet absorber (available from CYTEC INDUSTRIES, product name “Cyasorb UV-24”) was further compounded as an ultraviolet absorber.

Here, the details of the simplified names listed in Table 1 are as follows.

### <Light-Diffusing Fine Particles>

P1: Titanium oxide fine particles (available from Sakai Chemical Industry Co., Ltd., product name “R-62N,” indefinite shape, average particle diameter: 260 nm, refractive index: 2.7)

P2: Titanium oxide fine particles (available from Sakai Chemical Industry Co., Ltd., product name “R-25,” indefinite shape, average particle diameter: 200 nm, refractive index: 2.7)

P3: Zinc oxide fine particles (available from Sakai Chemical Industry Co., Ltd., product name “Fine zinc oxide,” indefinite shape, average particle diameter: 300 nm, refractive index: 2.1)

P4: Polymethyl methacrylate resin filler (available from Sekisui Kasei Co., Ltd., product name “SSX-101,” average particle diameter: 1.5 μm, refractive index: 1.49)

### <Testing Example 1> (Measurement of Luminance)

The release sheet was removed from the projection screen produced in each of Examples and Comparative Examples, then the projection screen was attached to a soda lime glass of 300 mm width×400 mm length×1.1 mm height via the exposed pressure sensitive adhesive layer, and this was used as a sample.

A short focus projector (available from RICOH COMPANY, LTD., product name “PJ WX4152N”) was installed at a position of 15 cm from the sample and on the side of the sample to which the projection screen was not attached. Then, in a dark room environment, a white image (white light) was projected onto the projection screen so that the luminance of the sample would be 1100 cd/m².

The luminance of the white light projected onto the projection screen was measured using a luminance meter (available from KONICA MINOLTA, INC., product name “LS-110”) from angles of frontal 0° (directly in front of the projector) and diagonal 45° on the opposite side of the sample to the projector. The luminance measurement was performed at a position of 100 cm from the projection screen.

In addition, from the above measurement results, the luminance ratio of the luminance at diagonal 45° (diagonal 45° luminance) to the luminance at frontal 0° (frontal 0° luminance) (diagonal 45° luminance/frontal 0° luminance) was calculated. The results are listed in Table 1.

### <Testing Example 2> (Measurement of Total Luminous Transmittance)

The pressure sensitive adhesive layer of the projection screen produced in each of Examples and Comparative Examples was attached to soda lime glass, and this was used as a sample for measurement. After background measurement was performed on the soda lime glass, the total luminous transmittance (%) of the above sample for measurement was measured according to JIS K7361-1:1997 using a haze meter (available from NIPPON DENSHOKU INDUSTRIES LTD., product name “NDH-5000”). The results are listed in Table 1.

### <Testing Example 3> (Measurement of Haze Value)

The pressure sensitive adhesive layer of the projection screen produced in each of Examples and Comparative Examples was attached to soda lime glass, and this was used as a sample for measurement. After background measurement was performed on the soda lime glass, the haze value (%) of the above sample for measurement was measured according to JIS K7136: 2000 using a haze meter (available from NIPPON DENSHOKU INDUSTRIES CO., LTD., product name “NDH-5000”). The results are listed in Table 1.

### <Testing Example 4> (Measurement of Luminous Transmittance)

The pressure sensitive adhesive layer of the projection screen produced in each of Examples and Comparative Examples was attached to soda lime glass, and this was used as a sample for measurement. After background measurement was performed on the soda lime glass, the transmittance of the above sample for measurement in a range of 200 to 1000 nm was measured using an ultraviolet-visible-near-infrared spectrophotometer (available from SHIMADZU CORPORATION, product name “UV-3600”), and the luminous transmittance (%) at a wavelength of 380 nm was extracted. The measurement was performed using the attached large sample chamber MPC-3100 without using the built-in integrating sphere. The results are listed in Table 1.

### <Testing Example 5> (Evaluation of Background Visibility)

The release sheet was removed from the projection screen produced in each of Examples and Comparative Examples, then the projection screen was attached to a soda lime glass of 300 mm width×400 mm length×1.1 mm height via the exposed pressure sensitive adhesive layer, and this was used as a sample.

An A4 sheet of paper on which characters (A, B, and C) and figures (∘, Δ, and ×) were displayed was placed at a position 100 cm away from the obtained sample and on the side of the sample to which the projection screen was not attached. The font size of these characters and figures was 144 points.

Then, in a state in which no image was projected from the projector, the characters/figures as a background were visually confirmed through the sample. The viewer confirmed the characters/figures at a position 100 cm away from the sample. Then, the background visibility was evaluated based on the following criteria. The results are listed in Table 1.

A: Characters/figures were clearly confirmed.

B: Characters/figures appeared blurry.

C: Characters/figures were not able to be recognized.

### <Testing Example 6> (Evaluation of Frontal Visibility/Diagonal Visibility)

The same samples as in Testing example 5 were prepared, and a short focus projector (available from RICOH COMPANY, LTD., product name “PJ WX4152N”) was installed at a position of 100 cm from a sample and on the side of the sample to which the projection screen was not attached. Then, the TV's inactive image (in which rectangular figures were arranged with various colors) was projected from the projector onto the projection screen.

The image projected onto the projection screen was visually confirmed from angles of frontal 0° (directly in front of the projector) and diagonal 45° on the opposite side of the sample to the projector. The viewer confirmed the projected image at a position 100 cm away from the sample. Then, the frontal visibility and the diagonal visibility were evaluated based on the following criteria. The results are listed in Table 1.

A: Boundaries of the image were clearly visible.

B: Boundaries of the image appeared blurred.

C: Boundaries of the image not able to be recognized.

### <Testing Example 7> (Evaluation of Reworkability)

The projection screen produced in each of Examples and Comparative Examples was cut into 25 mm width and 100 mm length, and this was used as a sample. The pressure sensitive adhesive layer of the above sample was attached to soda lime glass (available from Nippon Sheet Glass Company, Ltd.) under an environment of 23° C. and 50% RH and then pressurized at 0.5 MPa and 50° C. for 20 minutes in an autoclave available from KURIHARA SEISAKUSHO Co., Ltd. After that, the sample was left untouched under a condition of 23° C. and 50% RH for 24 hours, and the adhesive strength (N/25 mm) was then measured under a condition of a peel speed of 300 mm/min and a peel angle of 180° using a tensile tester (available from ORIENTEC Co., LTD., product name “TENSILON”). The measurement was conducted according to JIS Z0237: 2009 except for the condition described herein. Reworkability was evaluated based on the following criteria from the adhesive strength and the results of visually confirming the state of the adherend surface after peeling by measuring the adhesive strength. The results are listed in Table 1.

A: Adhesive strength was 1 N/25 mm or less, and no dirt or contamination caused by the pressure sensitive adhesive was observed on the adherend surface.

B: Adhesive strength was 1 N/25 mm or less, but dirt and contamination caused by the pressure sensitive adhesive were observed on the adherend surface.

C: Adhesive strength was more than 1 N/25 mm, and dirt and contamination caused by the pressure sensitive adhesive were observed on the adherend surface.

TABLE 1

| | Formulation of silicone-based | | | | | | |
|---|---|---|---|---|---|---|---|
| | pressure sensitive | | | | | | |
| | adhesive composition | | | | | | |
| | Light-diffusing | | UV | Luminance | | | Optical properties |
| | fine particles | | absorber | Frontal 0° | Diagonal 45° | | Total luminous |
| | | mass | mass | luminance | luminance | Luminance | transmittance |
| | Type | parts | parts | (cd/m²) | (cd/m²) | ratio | (%) |
| Example 1 | P1 | 0.1 | — | 33 | 31 | 0.94 | 86.7 |
| Example 2 | | 0.2 | — | 81 | 78 | 0.96 | 85.2 |
| Example 3 | | 0.3 | — | 108 | 99 | 0.93 | 84.3 |
| Example 4 | | 0.5 | — | 159 | 155 | 0.97 | 81.7 |
| Example 5 | | 0.2 | 4.0 | 84 | 80 | 0.95 | 84.2 |
| Example 6 | P2 | 0.2 | — | 80 | 77 | 0.96 | 84.2 |
| Example 7 | P3 | 0.5 | — | 94 | 90 | 0.96 | 87.1 |
| Comparative | P4 | 10 | — | 23 | 9 | 0.40 | 90.1 |
| Example 1 | | | | | | | |
| Comparative | P2 | 5.0 | — | 445 | 433 | 0.97 | 42.2 |
| Example 2 | | | | | | | |

| | Optical properties | | | | | |
|---|---|---|---|---|---|---|
| | Haze | 380 nm | Evaluation of visibility | | | Evaluation |
| | value | transmittance | Background | Frontal | Diagonal | of |
| | (%) | (%) | visibility | visibility | visibility | reworkability |
| Example 1 | 6.8 | 83.0 | A | B | B | A |
| Example 2 | 10.0 | 82.2 | A | A | A | A |
| Example 3 | 14.2 | 61.6 | A | A | A | A |
| Example 4 | 24.2 | 73.4 | B | A | A | A |
| Example 5 | 10.9 | 0.2 | A | A | A | A |
| Example 6 | 9.8 | 62.3 | A | A | A | A |
| Example 7 | 13.2 | 63.0 | A | A | A | A |
| Comparative | 23.4 | 84.9 | B | B | C | A |
| Example 1 | | | | | | |
| Comparative | 72.1 | 42.1 | C | A | A | A |
| Example 2 | | | | | | |

As found from Table 1, the projection screens produced in Examples were excellent in the frontal visibility and diagonal visibility when the projector was turned on, and were also excellent in the background visibility when the projector was turned off. Moreover, the projection screens produced in Examples were excellent in the reworkability.

### INDUSTRIAL APPLICABILITY

The projection screen of the present invention is suitably used as a transmissive projection screen that is used by being releasably attached to a show window, window glass, etc.

### DESCRIPTION OF REFERENCE NUMERALS

1 . . . Projection screen
   11 . . . Transparent base material
   12 . . . Pressure sensitive adhesive
   13 . . . Release sheet
2 . . . Optically transparent adherend
P . . . Projector
V1, V2 . . . Viewer

1. A projection screen used by being attached to an optically transparent adherend, the projection screen comprising:
a transparent base material; and
a pressure sensitive adhesive layer, wherein
a luminance at frontal 0° on the transparent base material side as measured using transmitted light from a white light source of 1100 cd/m² is 10 cd/m² or more and 400 cd/m² or less, and
a luminance ratio of a luminance at diagonal 45° on the transparent base material side as measured using transmitted light from a white light source of 1100 cd/m² with respect to the luminance at frontal 0° is 0.5 or more.

2. The projection screen according to claim 1, wherein the luminance at diagonal 45° on the transparent base material side as measured using the transmitted light from the white light source of 1100 cd/m² is 10 cd/m² or more and 400 cd/m² or less.

3. The projection screen according to claim 1, wherein its haze value is 1.0% or more and 70% or less.

4. The projection screen according to claim 1, wherein its total luminous transmittance is 50% or more.

5. The projection screen according to claim 1, wherein the pressure sensitive adhesive layer is composed of a silicone-based pressure sensitive adhesive composition.

6. The projection screen according to claim 1, wherein a pressure sensitive adhesive composition that constitutes the pressure sensitive adhesive layer contains light-diffusing fine particles.

7. The projection screen according to claim 6, wherein the light-diffusing fine particles are inorganic fine particles.

8. The projection screen according to claim 1, wherein a hard coat layer is provided on a surface of the transparent base material opposite to the pressure sensitive adhesive layer.
